(19) United States
(12) Patent Application Publication
(10) Pub. No.: US 2012/0139276 A1
(43) Pub. Date: Jun. 7, 2012

(54) ADJUSTABLE GRILL/GRIDDLE TONGS

(75) Inventors: David Green, Toronto (CA); David Chan, Scarborough (CA)

(73) Assignee: Browne & Co., Markham (CA)

(21) Appl. No.: 13/309,112

(22) Filed: Dec. 1, 2011

Related U.S. Application Data
(60) Provisional application No. 61/420,380, filed on Dec. 7, 2010.

(51) Int. Cl. B66C 1/42

(52) U.S. Cl. 294/86.4

(57) ABSTRACT

There is provided a pair of tongs for grasping items, particularly food from a grill or griddle. Prongs are sized and space to fit between gaps in the cooking surface to slide under the food. The spacing may be adjustable to size the tongs for different sizes of grill/griddle spacing. For example, mounting ends of the prongs are coupled for rotation within an end of an arm. Gears between the prongs permit the turning of one prong when the other is rotated. The rotation adjusts the relative spacing between parallel elongate portions of the tongs. The spacing adjustment allows the prongs to fit grills with different size spacing.

### FIELD

The present matter relates to tongs for gripping items and more particularly to adjustable tongs for grills and/or griddles.

### BACKGROUND

Tongs are widely used for gripping items such as food for cooking and/or serving. Some food cooking surfaces such, as grill or griddle tops are uneven. That is, the surfaces are not flat over a wide contiguous surface. In some grills or griddles, uniformly spaced gaps are present in the cooking surface. Grills or griddles of this nature may include Panini or other sandwich makers. Many grills for gas or other fueled grills and BBQ also present cooking surfaces with uniformly spaced gaps. Grasping items from such surfaces easily and effectively is desirable.

### SUMMARY

There is provided a pair of tongs for grasping items, particularly food from a grill or griddle. Prongs are sized and space to fit between gaps in the cooking surface to slide between the cooking surface and the food. The spacing may be adjustable to size the tongs for different sizes of grill/griddle spacing. For example, mounting ends of the prongs are coupled for selective rotation within an end of an arm. Gears between the prongs facilitate the turning of one prong when the other is rotated. The selective rotation adjusts the relative spacing between parallel elongate portions of the tongs. The spacing adjustment allows the prongs to fit grills with different size spacing.

### BRIEF DESCRIPTION OF THE DRAWINGS

The present matter may be further understood by reference to following description in conjunction with the appended drawings in which:

FIGS. 1A and 1B are respective partial end views of griddles showing different spacing in gaps in their cooking surfaces in accordance with the prior art;

FIG. 2 is a top plan view of a pair of tongs in a closed position in accordance with one example;

FIG. 3 is a side view of the pair of tongs of FIG. 2;

FIG. 4 is an enlarged cross-sectional view along line A-A of FIG. 3; and

FIG. 5 is an exploded perspective view of the tongs of FIG. 1, showing components of the gripping ends.

In the following description like numerals refer to like structures and processes in the diagrams.

### DETAILED DESCRIPTION

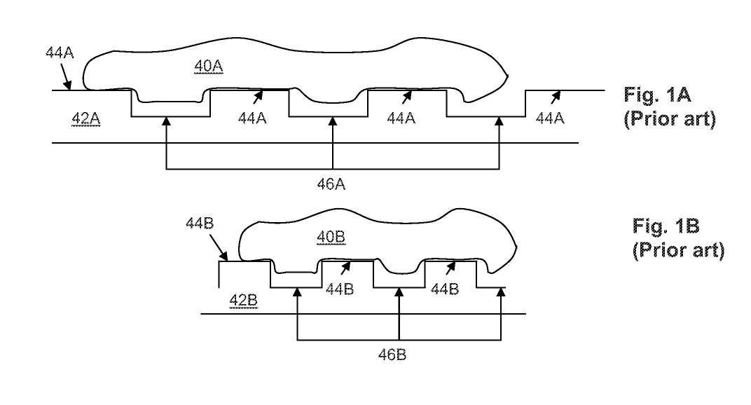

FIGS. 1A and 1B are schematic partial end views of two griddles, namely 42A and 42B, having upper cooking surface 44A and 44B for grilling food items 40A and 40B. Cooking surfaces on grills or griddles, whether electric appliances, griddle pans for operating on a stove/range top or BBQ or other grills, are generally characterized by evenly spaced, generally parallel gaps (e.g. 46A and 46B) in at least a portion of the cooking surface. The size of the spacing between the gaps may differ from griddle to griddle. The spacing between the gaps (e.g. 47B) in griddle 42B is closer than the spacing (e.g. 47A) in griddle 42A. The width (e.g. 48A) of an individual gap in a cooking surface is relatively narrow, for example, approximately 1 cm, sometimes less. It is also appreciated that there may be space (e.g. 49A) between a (bottom) surface (e.g. 52A) of the food product (e.g. 40A) and a recessed (bottom) surface (e.g. 50A) of a gap (46A, 47B) within which a utensil may be positioned, such as by sliding, to grasp and lift the food. A utensil sized to fit the spacing of gaps of griddle 42A may not fit the size of spacing other griddles with wider or narrower spacing.

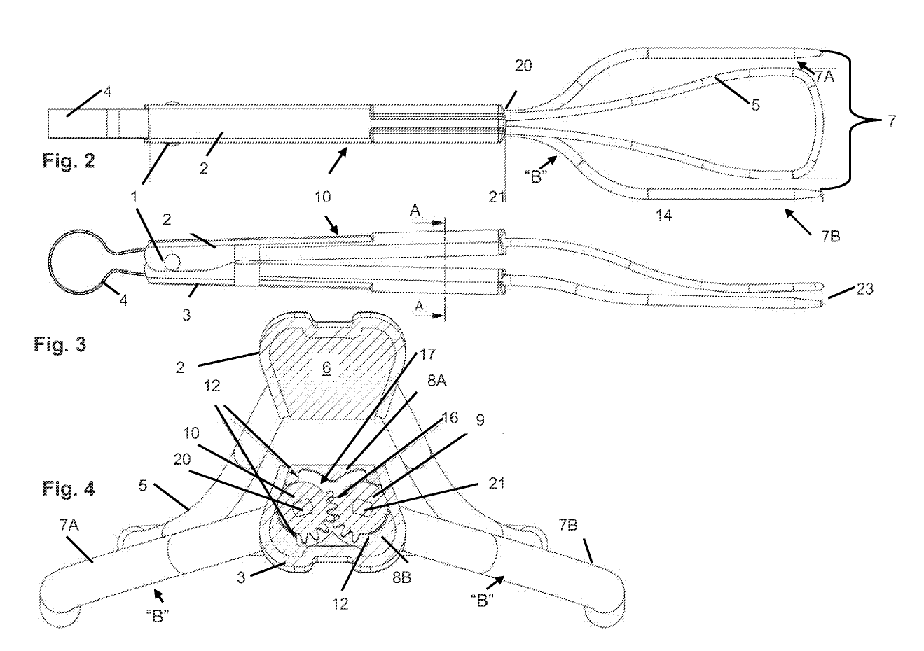

FIG. 2 is a top plan view and FIG. 3 a side view of a pair of tongs 100 (herein after tongs 100) in a closed position in accordance with one example. Tongs 100 comprise a pair of opposed arms (arm 2 and arm 3) coupled for pivoting about a hinge or pivot point (e.g. a pin) 1. Tongs 100 have a gripping end 14. Arm 2 is connected to gripping member 5 while arm 3 is connected to gripping member 7 comprising a pair of prongs 7A and 7B. Tongs 100 further comprise a locking mechanism 4 at an opposite end of end 14.

Various locking mechanisms may be used. In the present example a bow spring locking mechanism as shown and described in U.S. Pat. No. 6,056,338, entitled “Lockable Kitchen Tongs”, issued May 2, 2000 (incorporated herein by reference) is at least partially illustrated. Other locking mechanisms may include those described in U.S. Pat. No. 7,311,344 B2 entitled “Lockable Tongs”, issued Dec. 25, 2007 and also incorporated herein by reference.

Arm 2 and arm 3 are normally biased to an open position where the gripping members 5 and 7 are apart, when not locked or squeezed closed, such as via the locking mechanism or separate biasing mechanism such as a spring (not shown). Arm 2 and arm 3 may be generally defined of metal such as stainless steel which may be stamped and formed into shape such as to define respective channels therein within which to mount locking mechanism 4 or a biasing mechanism or gripping members as further described. Other materials may be used.

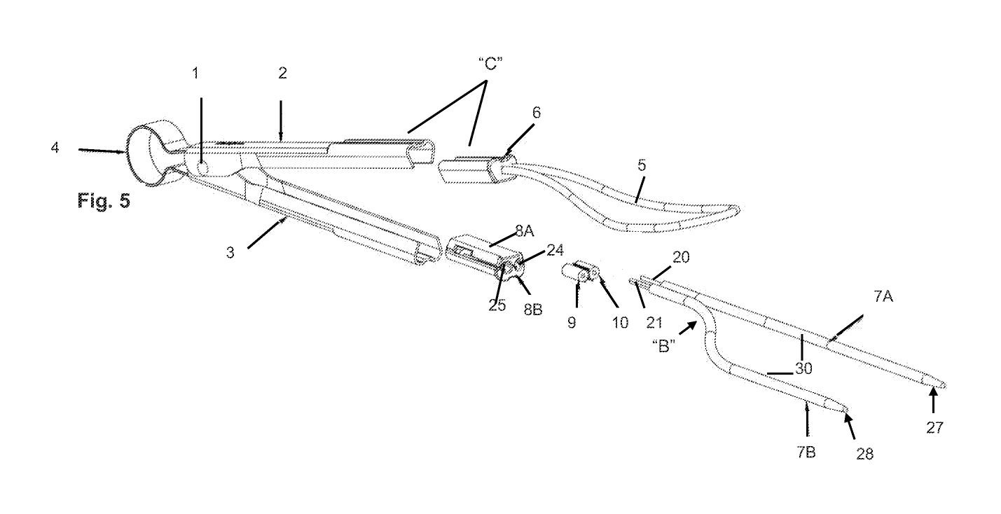

In the illustrated example, each of the gripping member 5 and prongs 7A and 7B comprises a thin, elongate or wire-like member having at least one end thereof connected to a respective arm. Gripping member 5 has two of its ends connected to arm 2 as further illustrated in FIG. 5. Gripping member 5 may be an alternative configuration. For example, gripping member 5 may be a relatively wide, flat surface such as a cooking flipper.

Each prong 7A and 7B has a free end 27, 28 for engaging food and an opposite mounting end 20, 21 for coupling to arm 3. In the present example, member 5 is permanently connected to arm 2, for example via body 6 (see arrow C in FIG. 5) which is at least partially slid into a channel defined by arm 2. Arm 2 may be squeezed around body 6. Gripping members 5 and 7 are pre-shaped (example by bending their wire-like structures) so that in a closed position the members are close to each other to assist with gripping food items such as sandwiches or other food to be grilled. In the present example, the wire-like gripping members 5 and 7 are coated with silicone, as an option. Coating of a core material such as stainless or other material stiffer that silicone is optional. In one alternative, the prongs 7A and 7B and/or gripping member 5 may be constructed of a hard plastic such as Nylon, for example.

Free ends 27, 28 (FIG. 5) of prongs 7A and 7B are tapered to assist with inserting the ends between a cooking surface and food thereon. Each free end 27, 28 is also offset from its opposite fixed end 20, 21 relative to the longitudinal axis of arm 3. The prongs 7A and 7B are relatively thin, to fit within gaps of the cooking surface. The prongs are shaped such that an extended portion (e.g. 30) of each prong runs generally parallel to the longitudinal axis of arm 3 (when coupled) but where the longitudinal axis of portion 30 is offset from the axis of arm 3. That is, within a prong, there is a “jog”, from end to end, shown at arrow B in the Figures. When mounted, arm 3 and portions 30 are not coaxial. Thus when the prongs 7A and 7B are mounted to arm 3, the free ends 27, 28 are spaced from one another to fit between different gaps in a grill or griddle surface. Each of prongs 7A and 7B are connected to arm 3 as further illustrated in FIGS. 4 and 5. Spacing between prongs 7A and 7B may be adjusted to fit different spacing requirements between gaps in grills or griddles.

In the illustrated example, the prongs are mounted for adjustable (e.g. user selectable) rotation to vary the spacing. However, other manners of mounting may be contemplated. Rotation of prongs 7A and 7B increases or decreases the spacing between respective portions 30 (and the free ends 27, 28) such that the member 7 may be sized to fit grills or griddle surfaces with different spacing in the gaps in the cooking surface.

Ends 20 and 21 of the prongs may be inserted into respective annular gear members (gears) 10 and 9. Gears 10 and 9 may be received in a body 8 comprising parts 8A and 8B. Body 8 may be fit into a channel defined by arm 3 at gripping end 14. Arm 3 may be tightened (e.g. clamped) around the body 8.

With reference to enlargement and cross-section FIG. 4 taken along lines A-A of FIG. 3, parts 8A and 8B may be shaped to define an chamber 17 for housing the gears 10 and 9 in a mating relationship where the gears mesh (16). With the ends 20, 21 so mounted in body 8, respective rotation about the end e.g. 20 of one prong e.g. 7A of member 7 will rotate the other prong 7B to facilitate adjustment of spacing for different grills. An interior surface of each of parts 8A and 8B in chamber 17 may define one or more respective stops 12 to prevent over rotation, in either direction, of gears 9, 10 on the gripping member 7.

Parts 8A and 8B may also define interior channels 24 and 25 for receiving portions of prongs 7A and 7B near ends 20 and 21, the channels being in communication with chamber 17.

Though described as wire-like structures, gripping members 5 and 7 need not have circular cross-sectional shapes. Relatively thin (i.e. relatively in thickness and width) prongs 7A and 7B of members 7 assist with fitting the prongs in spaces between gaps in the cooking surface and between cooking surface and food thereon.

There are alternative ways to achieve variable distances between prongs. Rather than use body 8, a body similar to 6 may be constructed that could have several spaced holes, horizontally aligned perpendicular to the arms, in which straight prongs could be plugged in and out of to create the correct distance. There could be a bar (not shown) perpendicular to the arm with a slot in it that the prongs and an attachment could slid along and then tightened with a set screw. A worm gear could be employed for rotation instead of the simple gears illustrated.

Though shown coupled at respective ends thereof, arm 2 and arm 3 and may be coupled in a middle portion. Ends opposite the grasping ends may be configured and operated like scissors.

It will be appreciated by those of ordinary skill in the art that the matter can be embodied in other specific forms without departing from the spirit of essential character thereof.

What is claimed is:

1. A pair of tongs to grasp items comprising:
a pair of gripping members mounted to respective arms of the tongs at a gripping end; and
at least one of the gripping members comprising a pair of prongs, the prongs spaced relative to one another and sized to fit between gaps in a cooking surface of a grill or griddle, thereby to slide under a food product on the cooking surface.

2. The pair tongs of claim 1 wherein the spacing of the prongs is adjustable.

3. The pair of tongs of claim 1 wherein the pair of prongs are mounted to an arm of the tongs for selective rotation to adjust the spacing between the tongs.

4. The pair of tongs of claim 1 wherein each prong comprises a thin, elongate member.

5. A pair of tongs to grasp items comprising:
a pair of gripping members mounted to respective arms of the tongs at a gripping end; and
at least one of the gripping members comprising a pair of prongs, each prong having a free end and an opposite mounting end, the mounting end coupled for rotation to one of the arms, each prong having an extended portion parallel to but offset from a longitudinal axis of the arm to which its mounted thereby to space the extended portion of the prongs relative to one another.

6. The tongs of claim 6 wherein the prongs are sized to fit between gaps in a cooking surface of a grill or griddle.

7. The tongs of claim 6 wherein the prongs are coupled to the arm for adjustable rotation about each mounting end to permit spacing of the prongs to fit cooking surfaces with different sized spacing in the gaps.

8. The tongs of claim 6 wherein the prongs are mounted via gears so that rotation of one prong rotates the other prong.

9. The tongs of claim 9 wherein the rotation of the gears is limited to prevent over rotation of the prongs.

10. The tongs of claim 6 wherein the free ends are tapered.
